(19) United States
(12) Patent Application Publication
(10) Pub. No.: US 2026/0139784 A1
(43) Pub. Date: May 21, 2026

(54) PIPELINE AIRMOVER ADAPTOR

(71) Applicant: George Munguia Gloria, Lake Havasu City, AZ (US)

(72) Inventor: George Munguia Gloria, Lake Havasu City, AZ (US)

(21) Appl. No.: 19/385,330

(22) Filed: Nov. 11, 2025

Related U.S. Application Data
(60) Provisional application No. 63/721,173, filed on Nov. 15, 2024.

(51) Int. Cl. F16L 55/07; F16L 55/24

(52) U.S. Cl. CPC F16L 55/07; F16L 55/24

(57) ABSTRACT

A pipeline adaptor for coupling an air mover to a pipeline around a blow-off port is disclosed. The pipeline adaptor securely couples the air mover to the pipeline and creates a tight seal between the air mover and the pipeline to optimize ventilation of the pipeline.

### FIELD

The present disclosure generally relates to pipeline products in the natural gas, crude, petroleum, oil, and liquids industries, and more particularly to an air mover adaptor.

### BACKGROUND

Pipelines have existed in rudimentary form dating back to ancient Mesopotamia. During the industrial revolution the first oil pipeline was built in Pennsylvania (circa 1865), marking a significant milestone in the transportation of materials used in the energy sector. Since that time, pipelines have become the standard for movement of materials across short and long distances. In the modern era pipelines have grown into sophisticated and extensive networks, like veins providing the lifeblood to the body, enabling the transportation of oil, natural gas, and other resources across countries and continents.

With the expansion of pipeline infrastructure, so too has grown the need for pipeline ventilation, such as during repair, expansion, or other types of maintenance. Pipelines are often equipped with blow-off ports on either side of a shut-off valve, enabling sections of the pipeline to be isolated and vented. Early ventilation systems included relying on natural airflow, but this type of ventilation becomes increasingly ineffective for longer stretches of pipeline. In the 20^{th} century mechanical blowers began to emerge using fans to create forced airflow, thereby venting gases and vapors more quickly. Blowers have become more efficient and compact over time until specialized air movers emerged as the primary means for pipeline ventilation.

However, air movers and the pipelines they are used to service have a number of drawbacks. Pipelines may have a number of bore sizes depending on the material being transported. As such, the blow-off ports also have different sizes, which means that air movers have to be sized to fit the pipeline for which they are used. Furthermore, air movers are handheld and must be carried up and placed over the blow-off port. During use of the air mover, vibration and other forces may cause the air mover to be dislodged from the blow-off port and may fall and be damaged. Ideally, the operator will not have to stand and hold the air mover throughout the ventilation process. In practice, operators have attempted to retain the air mover in place over the blow-off port through the use of duct tape, rachet straps, or both. Additionally, it may be advantageous to create an airtight seal between the air mover and the blow-off port to ensure air outside the pipeline isn't caused to pass through the wrong end of the air mover. In practice, operators have attempted to create a seal using duct tape.

Therefore, it would be desirable to optimize air mover placement, sealing, and/or retention over the blow-off port to improve performance of the operations performed by the air mover when venting the pipeline.

### SUMMARY

A pipeline adaptor includes a top side capable of interconnection with an air mover, a bottom side capable of interconnection with a pipeline over a blow-off port, and a sidewall extending below the top side to interact with the pipeline to retain interconnection between the bottom side and the pipeline around the blow-off port.

### BRIEF DESCRIPTION OF THE DRAWINGS

Various aspects and advantages will become apparent upon review of the following detailed description and upon reference to the drawings in which:

FIG. 1 is a photograph illustrating an isometric view of a portion of a pipeline having an air mover positioned over a blow-off port;

FIG. 2 illustrates an isometric view of a pipeline adaptor coupled to an air mover;

FIG. 3 illustrates an isometric view of a pipeline adaptor;

FIG. 4 illustrates a bottom view of a pipeline adaptor;

FIG. 5 illustrates a cross-sectional view of a pipeline adaptor;

FIG. 6 illustrates a top view of a pipeline adaptor;

FIG. 7 is a photograph illustrating an isometric view of a portion of a pipeline having an air mover secured over a blow-off port by a pipeline adaptor.

### DETAILED DESCRIPTION

The following disclosure includes a method and apparatus for securely coupling an air mover over a blow-off port of a pipeline. A pipeline adaptor may be securely coupled to pipeline at the blow-off port, and the air mover may be securely coupled to the adaptor. The adaptor may secure the air mover to the pipeline at the blow-off port. The adaptor may tightly seal the air mover to the pipeline at the blow-of port. Once the air mover is coupled securely and sealed tightly to the pipeline at the blow-off port, the air mover may be operated to induce ventilation of the pipeline.

While it may be common in some industries to refer to different segments of the pipeline using different names or categories (e.g., pipelines, flowlines, gathering lines, transmission lines, distribution lines, etc.), it is understood that the present disclosure contemplates use of the pipeline adaptor for all types of piping systems without regard to where they fall in the network, nor what material they are used to transport, and in all such cases may be commonly referred to in this disclosure as pipeline or pipelines.

This disclosure contemplates the various configurations of blow-off ports, including their various sizes and different means for attaching a blow-off cap. The pipeline adaptor discussed within this disclosure may be capable of universal attachment and/or alignment, or may be implemented in various sizes and/or with different attachment means to accommodate different pipelines and/or air movers without departing from the principles presented in this disclosure.

The usefulness of the principles presented in this disclosure may be obvious to a person of ordinary skill in the art. Before any work (e.g., cutting, welding, activities that may cause sparks, etc.) may be performed on a pipeline, it is expedient that all hazardous and/or flammable materials be removed from the pipeline, and that the pipeline be rendered innocuous. Failure to remove hazardous and/or flammable materials prior to performance of work may result in material spillage (e.g., leaking, flooding), adverse reactions (e.g., explosions, flareups, detonations), environmental pollution in the area where the work is to be performed (e.g., noise, light, water, soil, air, thermal pollution), and/or threat to the health and/or welfare of personnel on site (such as due to suffocation, burns, exposure to toxic fumes, etc.).

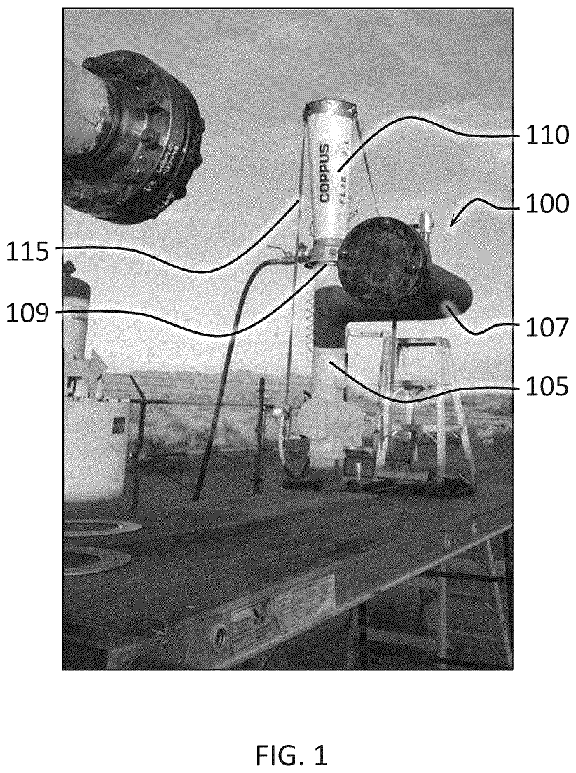

FIG. 1 illustrates a portion of a pipeline 100 having a vertical element 105 (e.g., a riser), and a horizontal element 107 (e.g., a transmission line). In FIG. 1, the horizontal element 107 may be under maintenance and a portion of the horizontal element may have been removed. During such maintenance, a blow-off port 109 may be opened, and an air mover 110 may be positioned over the blow-off port to facilitate ventilation of the pipeline.

Air mover 110 may be balanced over blow-off port 109 or may be secured by one or more rachet straps 115 extending from an upper edge of air mover 110 to a secure position (e.g., an anchor point) and/or by duct tape extending from air mover 110 to blow-off port 109. The use of rachet straps 115 and/or duct tape is unstable and does not create a good seal between air mover 110 and blow-off port 109. Furthermore, high vibration, pressure, and/or gas flow through air mover 110 may cause greater instability and/or lack of a good seal between air mover 110 and blow-off port 109.

Thus, this disclosure presents an improved, more secure way to couple an air mover over a blow-off port of a pipeline. Further, this disclosure presents an improved, more robust way to seal an air mover around a blow-off port of a pipeline.

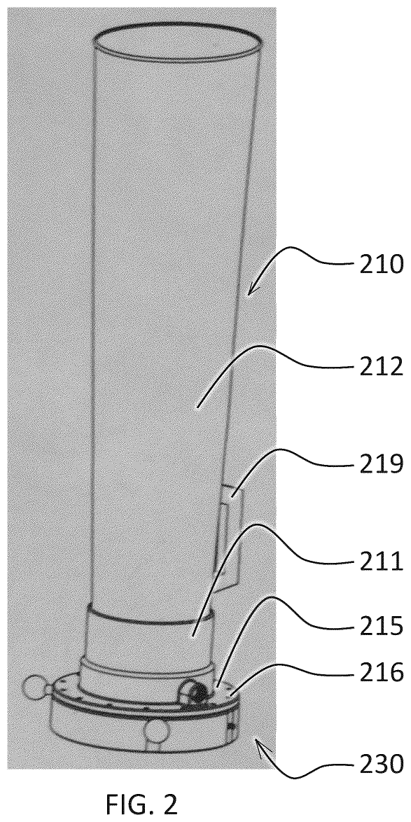

FIG. 2 illustrates a pipeline adaptor 230 coupled to an air mover 210. Air mover 210 may include an intake element 211 and an exhaust element 212. Exhaust element 212 may be coupled to intake element 211. Intake element 211 may have a flared and/or bell-shaped bottom extension 215 shaped to interface with the pipeline adaptor 230. Bottom extension 215 may include a plurality of apertures 216 formed during the manufacture of air mover 210. A handle 219 may be secured to one or both of intake element 211 and exhaust element 212 to enable easy carrying and positioning of air mover 210.

Ventilation may be performed by passing material from within the pipeline through air mover 210 (e.g., through intake element 211 and/or exhaust element 212). Ventilation may be induced within intake element 211. Ventilation may be induced by use of a motor, a fan, a pump, by creating a venturi vortex using pressurized air (e.g., 80 psi), or by any other suitable means.

Use of air mover 210 is optimized when no air from the atmosphere is permitted to pass into intake element 211 at bottom extension 215. Thus, bottom extension 215 may be sealed against a corresponding surface of pipeline adaptor 230 to prevent passage of air through the bottom of intake element 211. Securement of bottom extension 215 against the corresponding surface of pipeline adaptor 230 may be enabled by passing fasteners (e.g., bolts) through one or more of the plurality of apertures 216 into corresponding apertures of pipeline adaptor 230. A person of ordinary skill in the art will appreciate that various air movers 210 have different quantities of apertures with different configurations around the lower perimeter of intake element 211, thus the corresponding surface of pipeline adaptor 230 may be configured with sufficient corresponding apertures to accommodate various air movers 210 (e.g., 1, 2, 3, 4, 5, 6,7, 8, 9, 10, 11, 12, 13, 14, 15, 16, 17, 18, 19, 20, or more apertures having regular or irregular spacing).

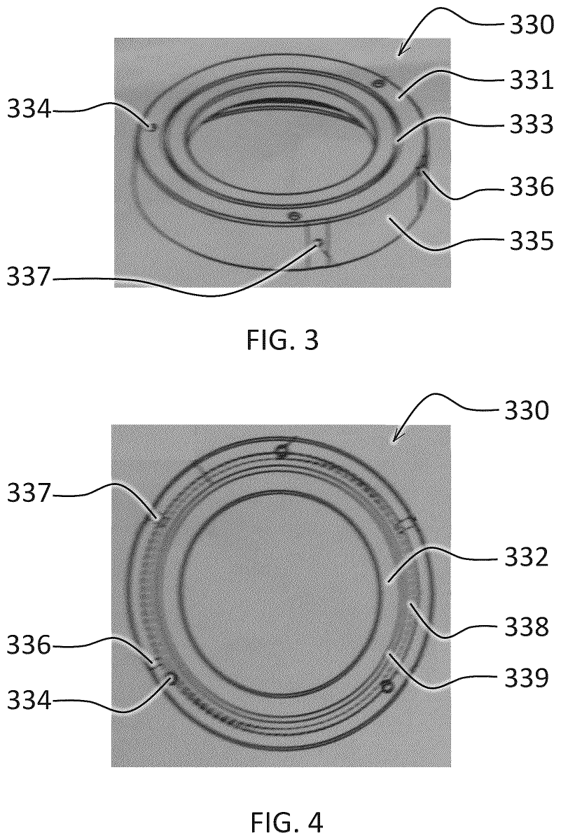

FIGS. 3 and 4 illustrate a pipeline adaptor 330. Pipeline adaptor 330 may be configured to interconnect with a pipeline around a blow-off port. Pipeline adaptor 330 may be configured to interconnect with an air mover. Pipeline adaptor 330 may have an approximately ring-shaped appearance (e.g., circular with an opening through the center of the circle). A top side 331 of pipeline adaptor 330 may interface with, couple to, or interconnect with a bottom portion of an intake of an air mover. A bottom side 332 of pipeline adaptor 330 may interface with, couple to, or interconnect with a pipeline around a blow-off port. Bottom side 332 may face oppositely of top side 331.

Top side 331 may include a seal 333 for creating an air-tight seal between top side 331 and an air mover. Seal 333 may extend around the inner perimeter of top side 331 (e.g., adjacent to a central opening extending through pipeline adaptor 330). Seal 333 may protrude from top side 331 such that compression of seal 333 may occur upon securement of top side 331 to an air mover.

Top side 331 may include a plurality of apertures 334 for receiving fasteners (e.g., threaded bolts). The plurality of apertures may be universally located to enable alignment with at least one or more of a plurality of apertures of an air mover. Fasteners may extend through corresponding apertures of an air mover and into one or more of the plurality of apertures to secure top side 331 to an air mover. Securement of fasteners through the plurality of apertures may cause seal 333 to be compressed between top side 331 and a corresponding surface of an air mover. Securement of fasteners through the plurality of apertures may cause an air-tight seal to be formed between top side 331 and a corresponding surface of an air mover.

Sidewall 335 may extend downward below top side 331 around a perimeter of top side 331. FIGS. 3 and 4 exemplify sidewall 335 extending around a perimeter of top side 331 at an outer edge of top side 331. This disclosure contemplates other arrangements. Sidewall 335 may extend around a perimeter of top side 331 at a position between an outer edge and an inner edge of top side 331. Sidewall 335 may extend around a perimeter of top side 331 at a position at an inner edge of top side 331.

Sidewall 335 may include a plurality of cavities 336 (e.g., threaded cavities). The plurality of cavities 336 may extend from an outer side into an interior of sidewall 335. The plurality of cavities 336 may not extend to an inner side of sidewall 335. One or more handle mounts (e.g., handle mounts 541 of FIG. 6) may be secured to each of the plurality of cavities 336 (e.g., having corresponding threaded shafts that can be interconnected with threaded cavities).

Sidewall 335 may have threading 338 extending around the inner side below bottom side 332. Threading 338 may be configured to interconnect with corresponding threading extending from the pipeline at a blow-off port. A seal 339 may extend from bottom side 332 for creating an air-tight seal between bottom side 332 and a corresponding surface of a pipeline. Seal 339 may protrude from bottom side 332 such that compression of seal 339 may occur upon securement of bottom side 332 to the corresponding surface of the pipeline.

Sidewall 335 may include a plurality of holes 337 (e.g., threaded holes). The plurality of holes 337 may extend from an outer side to an inner side of sidewall 335. One or more locking screws (e.g., locking screws 542 of FIG. 6) may be secured to each of the plurality of holes 337 (e.g., threadably engaged within the plurality of holes 337). After pipeline adaptor 330 has been secured to a pipeline around a blow-off port (e.g., threadably engaging threading 338 to corresponding threading of the pipeline), locking screws may be engaged within the plurality of holes 337 to engage the pipeline. In this way, locking screws may secure pipeline adaptor 330 against loosening, rattling, or other movement during the ventilation process (e.g., as the result of vibration).

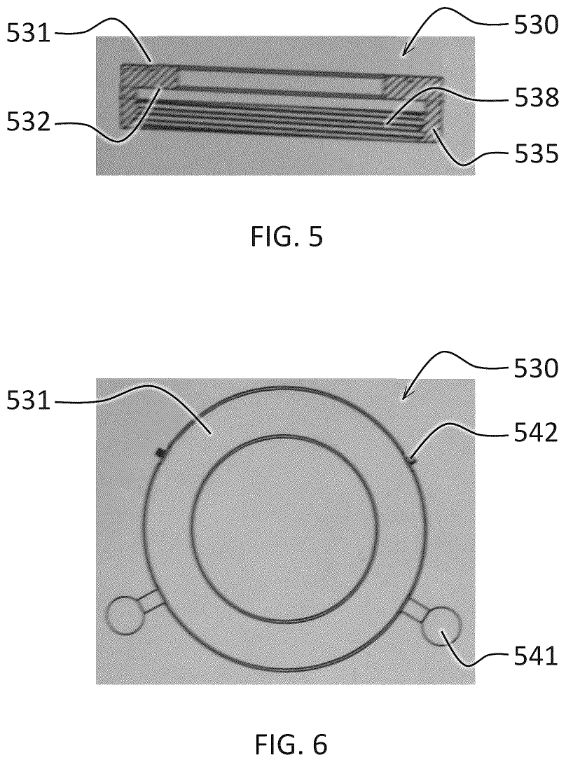

FIGS. 5 and 6 illustrate a pipeline adaptor 530. Pipeline adaptor 530 may be configured to interconnect with a pipeline around a blow-off port (e.g., a threaded blow-off port). Pipeline adaptor 530 may be configured to interconnect with an air mover. A top side 531 of pipeline adaptor 530 may interface with, couple to, or interconnect with a bottom portion of an intake of an air mover. A bottom side 532 of pipeline adaptor 530 may interface with, couple to, or interconnect with a pipeline around a blow-off port.

Sidewall 535 may extend downward below top side 531 around a perimeter of top side 531. FIGS. 5 and 6 exemplify sidewall 535 extending downward from top side 531 at an outer edge of top side 531. This disclosure contemplates other arrangements. Sidewall 535 may include threading 538 extending around the inner surface below bottom side 532. Threading 538 may be configured to interconnect with corresponding threading extending from the pipeline at a blow-off port.

Handle mounts 541 may extend from pipeline adaptor 530 (e.g., from sidewall 535, top side 531, or both). Handle mounts 541 may extend from one or more of a plurality of apertures of top side 531 and/or from one or more of a plurality of cavities of sidewall 535. Handle mounts 541 may enable an operator to easy handle pipeline adaptor 530, position pipeline adaptor 530 into a position abutting a pipeline around the blow-off port, and/or move pipeline adaptor 530 into a tightened, interconnected configuration with a pipeline. In situations where there is low clearance due to other environmental conditions, handle mounts 541 may be removed and/or moved to other attachment points for convenience.

Locking screws 542 may extend from pipeline adaptor 530 (e.g., from sidewall 535, top side 531, or both). Locking screws 542 may extend from one or more of a plurality of apertures of top side 531 and/or from one or more of a plurality of holes of sidewall 535. Locking screws 542 may enable an operator to easily lock pipeline adaptor 530 against a pipeline to retain it against movement or becoming dislodged (e.g., due to vibration during operation of an air mover).

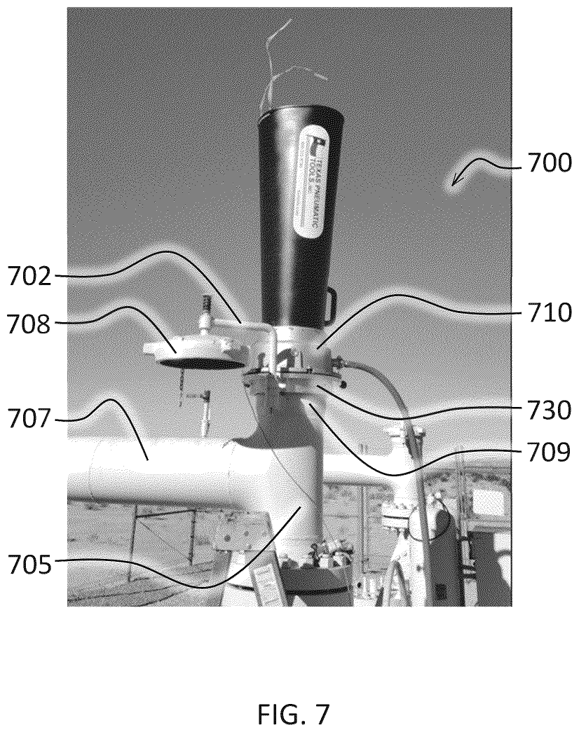

FIG. 7 illustrates a portion of a pipeline 700 having a vertical element 705 (e.g., a riser), and a horizontal element 707 (e.g., a transmission line). In FIG. 7, the horizontal element 707 may be under maintenance. During such maintenance, a blow-off port 709 may be opened (e.g., removing and/or unscrewing a blow-off cap 708 suspended by a cap arm 702). Next, a pipeline adaptor 730 may be secured over blow-off port 709 in the manner presented in this disclosure (e.g., threading and/or screwing pipeline adaptor 730 into place around blow-off port 709). Next, an air mover 710 may be secured to the top of pipeline adaptor 730 over blow-off port 709 to facilitate ventilation of the pipeline.

Air mover 710 may be secured over blow-off port 709 without the need to be balanced and without the need to be retained by rachet straps and/or duct tape. The use of pipeline adaptor 730 may be sufficiently stable to retain air mover 710 during high vibration, high wind, and so forth. Further, the use of pipeline adaptor 730 may be sufficient to create a good seal between air mover 710 and blow-off port 709 to prevent air from being sucked into air mover 710 from the wrong direction.

Thus, this disclosure presents an improved, more secure way to couple an air mover 710 over a blow-off port 709 of a pipeline 700. Further, this disclosure presents an improved, more robust way to seal an air mover 710 around a blow-off port 709 of a pipeline 700.

Other aspects will be apparent to those skilled in the art from consideration of the specification and practice disclosed herein. It is intended, therefore, that the specification and illustrated figures be considered as examples only.

What is claimed is:

1. A pipeline adaptor, comprising:
a top side capable of interconnection with an air mover;
a bottom side capable of interconnection with a pipeline over a blow-off port; and
a sidewall extending below the bottom side to interact with the pipeline to retain interconnection between the bottom side and the pipeline around the blow-off port.

2. The pipeline adaptor of claim 1, wherein the top side includes a plurality of apertures.

3. The pipeline adaptor of claim 2, wherein the plurality of apertures are universally located for alignment with a plurality of apertures of the air mover.

4. The pipeline adaptor of claim 3, wherein fasteners extend through the plurality of apertures of the air mover into the plurality of apertures of the top side to retain the air mover against the top side.

5. The pipeline adaptor of claim 1, wherein the top side includes a seal capable of sealing against the air mover to create a seal between the pipeline adaptor and the air mover.

6. The pipeline adaptor of claim 1, wherein the sidewall includes a plurality of holes for receiving one or more locking screws to retain the sidewall against the pipeline.

7. A pipeline adaptor capable of interconnection with an air mover and interconnection with a pipeline over a blow-off port, comprising:
a top side having a plurality of apertures;
a bottom side facing oppositely of the top side; and
a sidewall extending from the bottom side to interact with the pipeline to retain interconnection between the bottom side and the pipeline around the blow-off port.

8. The pipeline adaptor of claim 7, wherein the top side is capable of interconnection with the air mover, and wherein the bottom side is capable of interconnection with the pipeline.

9. The pipeline adaptor of claim 7, wherein the bottom side includes a seal capable of sealing against the pipeline to create a seal between the pipeline adaptor and the pipeline.

10. The pipeline adaptor of claim 7, wherein the sidewall includes a plurality of cavities for receiving one or more handle mounts for easy positioning of the pipeline adaptor.

11. The pipeline adaptor of claim 7, wherein the plurality of apertures are located around a perimeter of the top side between an outer edge and an inner edge and corresponding to a location of a plurality of apertures of the air mover.

12. The pipeline adaptor of claim 11, wherein fasteners extend through the plurality of apertures of the air mover into the plurality of apertures of the top side to retain the air mover against the top side.

13. A method of sealing an air mover to a pipeline over a blow-off port, the method comprising:
coupling a bottom side of a pipeline adaptor to the pipeline over a blow-off port;
coupling a sidewall of the pipeline adaptor to the pipeline around a blow-off port; and
coupling the air mover to a top side of the pipeline adaptor.

14. The method of claim 13, wherein the top side includes a plurality of apertures.

15. The method of claim 14, wherein the plurality of apertures are located around a perimeter of the top side for universal alignment with a plurality of apertures of the air mover, and wherein fasteners extend through the plurality of apertures of the air mover into the plurality of apertures of the top side to retain the air mover against the top side.

16. The method of claim 13, wherein the top side includes a seal capable of sealing against the air mover to create a seal between the pipeline adaptor and the air mover.

17. The method of claim 13, wherein the bottom side includes a seal capable of sealing against the pipeline to create a seal between the pipeline adaptor and the pipeline.

18. The method of claim 13, wherein the sidewall includes threading around an inner side capable of interconnecting with corresponding threading of the pipeline to retain the bottom side against the pipeline.

19. The method of claim 13, wherein the sidewall includes a plurality of cavities for receiving one or more handle mounts for easy positioning of the pipeline adaptor.

20. The method of claim 13, wherein the sidewall includes a plurality of holes for receiving one or more locking screws to retain the sidewall against the pipeline.
